(19) United States
(12) Patent Application Publication
(10) Pub. No.: US 2025/0383197 A1
(43) Pub. Date: Dec. 18, 2025

(54) SPECTROSCOPE AND OPTICAL DEVICE

(71) Applicant: Tokyo Seimitsu Co., Ltd., Tokyo (JP)

(72) Inventors: Yoshiyuki KAWATA, Tsuchiura-city (JP); Hideki MORII, Tsuchiura-city (JP)

(73) Assignee: Tokyo Seimitsu Co., Ltd., Tokyo (JP)

(21) Appl. No.: 19/235,022

(22) Filed: Jun. 11, 2025

(30) Foreign Application Priority Data
Jun. 12, 2024 (JP) 2024-095068

(51) Int. Cl. G01B 11/24; G01J 3/42

(52) U.S. Cl. CPC G01B 11/24; G01J 3/42

(57) ABSTRACT

The spectroscope includes: a spectroscopic element configured to disperse incident light (reflected light) in accordance with wavelengths; a detector (line sensor) having a plurality of pixels and configured to receive wavelength-specific light components obtained through light dispersion by the spectroscopic element at ones different from each other of the pixels; and a low-emissivity member provided on at least one of a first-direction side and a second-direction side of the spectroscopic element and the detector in a case where a one-direction side of a light dispersion direction of the spectroscopic element is the first-direction side, and an other-direction side of the light dispersion direction is the second-direction side.

### CROSS-REFERENCE TO RELATED APPLICATIONS

This application claims the priority benefit under 35 U.S.C. § 119 of Japanese Patent Application No. 2024-095068 filed on Jun. 12, 2024, which is hereby incorporated in its entirety by reference.

### BACKGROUND OF THE INVENTION

### Field of the Invention

The present invention relates to a spectroscope and an optical device including the spectroscope.

### Description of the Related Art

Known measurement devices which measure a surface shape (a displacement) of a measurement object include a displacement gage based on a color confocal method. Such a displacement gage includes a color confocal optical system and a spectroscope. The color confocal optical system emits measurement light toward a surface of a measurement object. Reflected light of the measurement light which is reflected from the surface of the measurement object comes incident on the color confocal optical system. The color confocal optical system emits, to the spectroscope, reflected light of measurement light within a wavelength range which is focused on the surface of the reflected light reflected from the surface of the measurement object.

The spectroscope includes a spectroscopic element and a line sensor (see Patent Literature 1). The spectroscopic element disperses reflected light (incident light) incident from the color confocal optical system. The line sensor has a plurality of pixels arrayed in a straight line and receives wavelength-specific light components obtained through light dispersion by the spectroscopic element at pixels different from each other. A surface shape of the measurement object can be computed based on light reception signals representing wavelength-specific reflected light intensities output from the line sensor.

### CITATION LIST

### Patent Literature

Patent Literature 1: Japanese Patent Application Laid-Open No. 2021-67611

### SUMMARY OF THE INVENTION

In a case where a light source, such as an LED (Light Emitting Diode), is arranged in the vicinity of a spectroscope, a part of the spectroscope may be warmed by light leaking out from the light source, radiant light from a region heated by the light source, and the like. This may result in a temperature gradient in the spectroscope. This affects wavelength calibration (a relationship between pixels of a line sensor and wavelengths of light components to be received) of the spectroscope to degrade precision of the spectroscope.

For example, one conceivable way to inhibit such degradation in precision of a spectroscope is to wait for the spectroscope to rise in temperature due to LED light emission from a light source and perform spectroscope calibration (acquisition of a correlation between pixels of a line sensor and wavelengths of light components to be received) in a state where the spectroscope and the light source are in thermal equilibrium. However, in this case, measurement by a displacement gage cannot be started until the spectroscope and the like reach a state of thermal equilibrium. Additionally, in a case where an LED light amount of the light source is changed, the spectroscope reaches a state of thermal equilibrium different from a state of thermal equilibrium before the change of the LED light amount to degrade the precision of the spectroscope.

The present invention has been made in view of the above-described circumstances, and has as its object to provide a spectroscope with precision improved compared to before and an optical device including the spectroscope.

A spectroscope for achieving the object of the present invention includes: a spectroscopic element configured to disperse incident light in accordance with wavelengths; a detector having a plurality of pixels and configured to receive wavelength-specific light components obtained through light dispersion by the spectroscopic element at ones different from each other of the pixels; and a low-emissivity member provided on at least one of a first-direction side and a second-direction side of the spectroscopic element and the detector in a case where a one-direction side of a light dispersion direction of the spectroscopic element is the first-direction side, and an other-direction side of the light dispersion direction is the second-direction side.

According to the spectroscope, a temperature gradient in the light dispersion direction of the spectroscope can be reduced.

In a spectroscope according to another aspect of the present invention, in a case where a direction parallel to a plane including the wavelength-specific light components obtained through light dispersion by the spectroscopic element and perpendicular to the light dispersion direction is a first perpendicular direction, and a one-direction side of the first perpendicular direction is a third-direction side, the detector is provided on the third-direction side of the spectroscopic element. With this configuration, a temperature gradient in the light dispersion direction of the spectroscope can be reduced.

In a spectroscope according to another aspect of the present invention, the low-emissivity member includes low-emissivity members provided on the first-direction side and the second-direction side of the spectroscopic element and the detector. With this configuration, a temperature gradient in the light dispersion direction of the spectroscope can be reduced.

In a spectroscope according to another aspect of the present invention, in a case where a high-temperature portion at a higher temperature than the spectroscope is provided on the first-direction side or the second-direction side of the spectroscopic element and the detector, the low-emissivity member is provided between the spectroscopic element and the detector, and the high-temperature portion. With this configuration, a temperature gradient in the light dispersion direction of the spectroscope can be reduced.

A spectroscope according to another aspect of the present invention includes high-emissivity members provided on a fourth-direction side of the spectroscopic element and the third-direction side of the detector in a case where an other-direction side of the first perpendicular direction is the fourth-direction side. With this configuration, a temperature gradient in the light dispersion direction of the spectroscope can be reduced, and the spectroscope can be brought into thermal equilibrium with a surrounding environment in a shorter time. This allows achievement of both improvement of precision of the spectroscope and improvement of economic efficiency.

In a spectroscope according to another aspect of the present invention, in a case where an other-direction side of the first perpendicular direction is a fourth-direction side, a direction perpendicular to the light dispersion direction and the first perpendicular direction is a second perpendicular direction, a one-direction side of the second perpendicular direction is a fifth-direction side, and an other-direction side of the first perpendicular direction is a sixth-direction side, the low-emissivity member further comprises low-emissivity members provided on the fourth-direction side of the spectroscopic element and the third-direction side of the detector, and the spectroscope includes high-emissivity members provided on the fifth-direction side and the sixth-direction side of the spectroscopic element and the detector. This allows achievement of both improvement of the precision of the spectroscope and improvement of economic efficiency.

In a spectroscope according to another aspect of the present invention, the detector is a line sensor having a plurality of pixels arrayed in the light dispersion direction.

An optical device for achieving the object of the present invention includes: the above-described spectroscope, a high-temperature portion provided on the first-direction side or the second-direction side of the spectroscope and at a higher temperature than the spectroscope; and a partition wall provided between the spectroscope and the high-temperature portion.

According to the optical device, since radiant heat from the high-temperature portion is transferred to the spectroscope while coming around the partition wall, a heat flow only to a particular surface of the spectroscope can be inhibited from increasing. As a result, temperature uniformity of the spectroscope is enhanced, which allows further improvement of the precision of the spectroscope.

In an optical device according to another aspect of the present invention, an opening portion is formed in the partition wall. This allows uniformization of a temperature distribution of the spectroscope in a shorter time.

In an optical device according to another aspect of the present invention, the high-temperature portion is a light source unit.

The present invention can improve precision of a spectroscope.

### BRIEF DESCRIPTION OF THE DRAWINGS

FIG. 1 is a schematic diagram of a displacement gage according to a first embodiment;

FIG. 2 is an enlarged diagram of a controller according to the first embodiment;

FIG. 3 is an enlarged view of a part of a line sensor shown in FIG. 2;

FIG. 4 is a graph showing an example of wavelength-specific reflected light intensities of reflected light to be detected by the line sensor;

FIG. 5 is a diagram showing an example of a spectroscope according to a comparative example without a low-emissivity member;

FIG. 6 is an explanatory diagram for explaining a problem with the spectroscope according to the comparative example;

FIG. 7 is an explanatory diagram for explaining low-emissivity members of the spectroscope;

FIG. 8 shows an enlarged view of the low-emissivity member in a dotted circle C1 in FIG. 7 and an enlarged view of the low-emissivity member in a dotted circle C2 in FIG. 7;

FIG. 9 is views showing a modification of the low-emissivity member in the dotted circle Cl in FIG. 7 and a modification of the low-emissivity member in the dotted circle C2 in FIG. 7;

FIG. 10 is a diagram showing a case where there is a temperature gradient in a Y direction in the spectroscope;

FIG. 11 is a diagram showing a case where there is a temperature gradient in an X direction in the spectroscope;

FIG. 12 is a schematic diagram of a spectroscope of a displacement gage according to a second embodiment;

FIG. 13 is a schematic diagram of a spectroscope of a displacement gage according to a third embodiment;

FIG. 14 is a view of a spectroscope of a displacement gage according to a fourth embodiment as viewed from an X-direction side;

FIG. 15 is a view of the spectroscope of the displacement gage according to the fourth embodiment as viewed from a +Z-direction side; and

FIG. 16 is a schematic diagram of a controller of a displacement gage according to a fifth embodiment.

### DESCRIPTION OF THE EMBODIMENTS

### First Embodiment

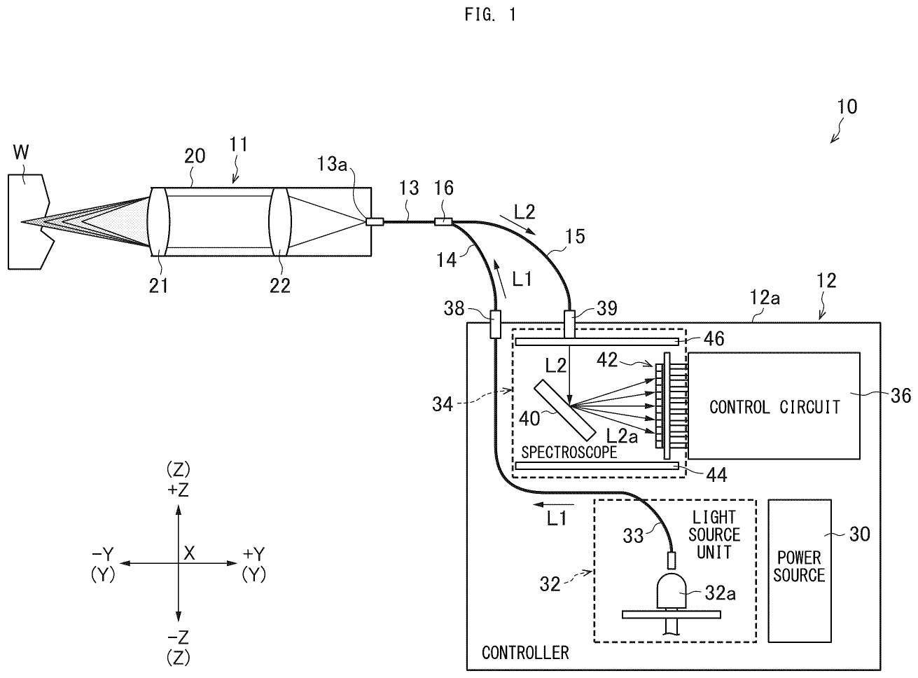

FIG. 1 is a schematic diagram of a displacement gage 10 according to a first embodiment. As shown in FIG. 1, the displacement gage 10 corresponds to an optical device according to the present invention and measures a surface shape (a displacement and a distance to a surface) of a workpiece W as an object to be measured. Note that X, Y, and Z directions in FIG. 1 are orthogonal to one another.

The displacement gage 10 includes a color confocal optical system 11, a controller 12, optical fiber cables 13, 14, and 15, and an optical fiber coupler 16. One end of the optical fiber cable 13 is connected to the color confocal optical system 11, and the optical fiber coupler 16 is connected to the other end of the optical fiber cable 13. The optical fiber coupler 16 connects together the other end of the optical fiber cable 13 and one ends of the optical fiber cables 14 and 15. The other ends of the optical fiber cables 14 and 15 are connected to the controller 12.

The controller 12 emits measurement light L1 which is white light to the color confocal optical system 11 via the optical fiber cable 14, the optical fiber coupler 16, and the optical fiber cable 13. The controller 12 disperses and receives reflected light L2 of the measurement light L1 which comes incident from the color confocal optical system 11 via the optical fiber cable 13, the optical fiber coupler 16, and the optical fiber cable 15 and computes the surface shape of the workpiece W.

The color confocal optical system 11 includes a lens-barrel 20 in the shape of a bottomed cylinder, an objective lens 21, and an ocular 22.

The objective lens 21 is provided at a distal-end-side opening portion of the lens-barrel 20, and the ocular 22 is provided inside the lens-barrel 20. The one end of the optical fiber cable 13 is connected to a bottom portion of the lens-barrel 20, and a fiber end face 13a which is an end face of the one end faces the ocular 22 inside the lens-barrel 20. With this configuration, the measurement light L1 incident from the controller 12 via the optical fiber cable 14, the optical fiber coupler 16, and the optical fiber cable 13 is emitted from the fiber end face 13a toward the ocular 22, and passes through the ocular 22 to come incident on the objective lens 21.

The objective lens 21 concentrates the measurement light L1 incident through the ocular 22 on the surface of the workpiece W. At this time, in-focus positions differ among wavelengths of the measurement light L1 due to chromatic aberrations of the objective lens 21. Rays of the reflected light L2, which are reflected from the surface of the workpiece W, of the measurement light L1 with wavelengths come incident on the objective lens 21, which emits the rays of the reflected light L2 toward the ocular 22.

The ocular 22 forms, on the fiber end face 13a, an image of only rays of the reflected light L2 of rays within a wavelength range of the measurement light L1, an image of the rays of the measurement light L1 being formed on the surface of the workpiece W. Since the fiber end face 13a functions as a diaphragm, only the rays of the reflected light L2 of the rays within the wavelength range of the measurement light L1, the image of which is formed on the surface of the workpiece W, are emitted to the controller 12 via the optical fiber cable 13, the optical fiber coupler 16, and the optical fiber cable 15.

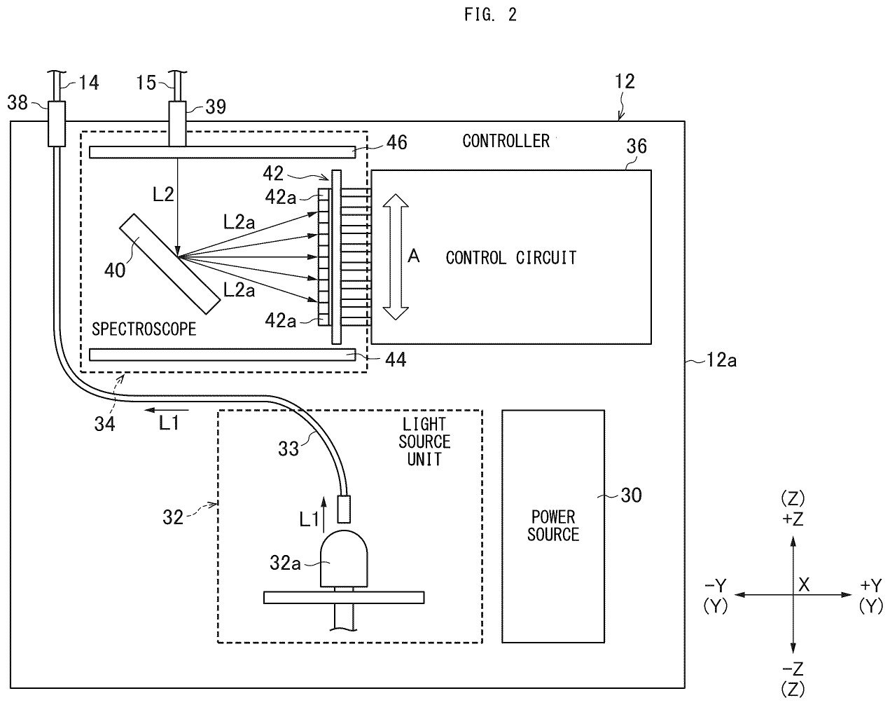

FIG. 2 is an enlarged diagram of the controller 12 according to the first embodiment. As shown in FIG. 2 and FIG. 1 described earlier, the controller 12 includes a power source 30, a light source unit 32, a spectroscope 34, a control circuit 36, and a case 12a which houses the units. An exit connector 38 to which the other end of the optical fiber cable 14 is connected and an entrance connector 39 to which the other end of the optical fiber cable 15 is connected are provided at the case 12a.

The power source 30 supplies power for driving to the light source unit 32 and the control circuit 36.

The light source unit 32 includes an LED light source 32a and an optical fiber cable 33. The LED light source 32a emits the measurement light L1. Note that a light source other than an LED may be used. The optical fiber cable 33 has one end arranged at a position facing the LED light source 32a and the other end connected to the exit connector 38. With this configuration, the measurement light L1 emitted from the LED light source 32a comes incident on the color confocal optical system 11 via the optical fiber cable 33, the exit connector 38, the optical fiber cable 14, the optical fiber coupler 16, and the optical fiber cable 13.

The entrance connector 39 is connected to the spectroscope 34, and the reflected light L2 comes incident from the entrance connector 39. The spectroscope 34 disperses the reflected light L2 (corresponding to incident light according to the present invention) incident from the entrance connector 39 and detects intensities of wavelength-specific light components L2a. The spectroscope 34 includes a spectroscopic element 40, a line sensor 42, and low-emissivity members 44 and 46.

For example, a diffraction grating is used as the spectroscopic element 40. The spectroscopic element 40 disperses the reflected light L2 incident from the entrance connector 39 in a −Z direction and emits the wavelength-specific light components L2a toward the line sensor 42 that is located on a +Y direction side of the spectroscopic element 40. An arrow in FIG. 2 indicates a light dispersion direction A of the spectroscopic element 40.

Note that the light dispersion direction A of the spectroscopic element 40 is a direction intersecting a traveling direction (a direction from the spectroscopic element 40 toward the line sensor 42: a +Y direction) of the light components L2a with respective wavelengths obtained through light dispersion by the spectroscopic element 40 in a plane (a YZ plane here) including the light components L2a with the respective wavelengths and is the Z direction in the present embodiment. In a case where the light dispersion direction A is the Z direction, the Y direction that is parallel to the YZ plane including the light components L2a with the respective wavelengths and perpendicular to the Z direction corresponds to a first perpendicular direction according to the present invention. The X direction corresponds to a second perpendicular direction according to the present invention.

Although a diffraction grating is described as an example of the spectroscopic element 40 in the present embodiment, a prism, an optical filter, or the like may be adopted instead. In this case, a position of the entrance connector 39 is appropriately changed depending on the type of the spectroscopic element 40.

The line sensor 42 corresponds to a detector according to the present invention and is arranged on the +Y-direction side (corresponding to a third-direction side according to the present invention) of the spectroscopic element 40, as described earlier. The line sensor 42 includes a plurality of pixels 42a (also referred to as light-receiving elements) which are arranged in a row along the light dispersion direction A (Z direction). The line sensor 42 receives the wavelength-specific light components L2a obtained through light dispersion by the spectroscopic element 40 at ones different from each other of the pixels 42a and outputs light reception signals indicating respective light component intensities (reflected light intensities) of the pixels 42a to the control circuit 36.

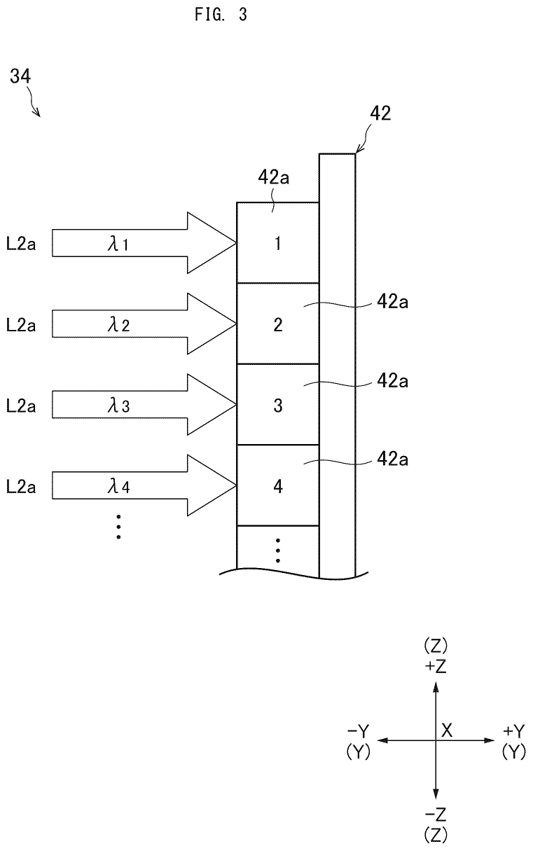

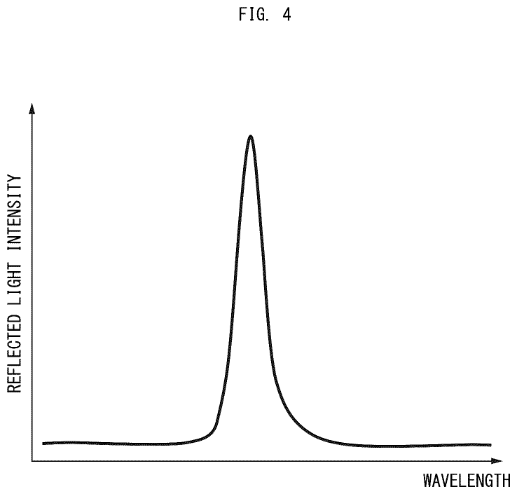

FIG. 3 is an enlarged view of a part of the line sensor 42 shown in FIG. 2. FIG. 4 is a graph showing an example of wavelength-specific reflected light intensities of the reflected light L2 (the light components L2a in the respective wavelength ranges) to be detected by the line sensor 42. Note that the pixels 42a of the line sensor 42 are assigned pixel numbers (1, 2, 3, . . . ) from a +Z-direction side toward a −Z-direction side in FIG. 3.

As shown in FIG. 3, wavelength calibration is performed in advance using a light source which emits light with known wavelengths in the spectroscope 34. Wavelength calibration refers to acquiring a relationship between the pixels 42a (pixel numbers) of the line sensor 42 and wavelengths (λ₁, λ₂, λ₃, λ₄, . . . ) of the light components L2a that come incident on the pixels 42a. Based on a result of the wavelength calibration and respective light reception signals (signal intensities) for the pixels 42a of the line sensor 42, wavelength-specific reflected light intensities of the reflected light L2 as shown in FIG. 4 are obtained.

Refer back to FIGS. 1 and 2. The low-emissivity members 44 and 46 will be described later. The control circuit 36 controls operation of the LED light source 32a and the line sensor 42. The control circuit 36 also computes wavelength-specific reflected light intensities of the reflected light L2 as shown in FIG. 4 described earlier based on light reception signals output from the pixels 42a of the line sensor 42 and a result of wavelength calibration described earlier and computes a distance to the surface of the workpiece W by a publicly known method based on a result of the computation. This allows measurement of the surface shape of the workpiece W.

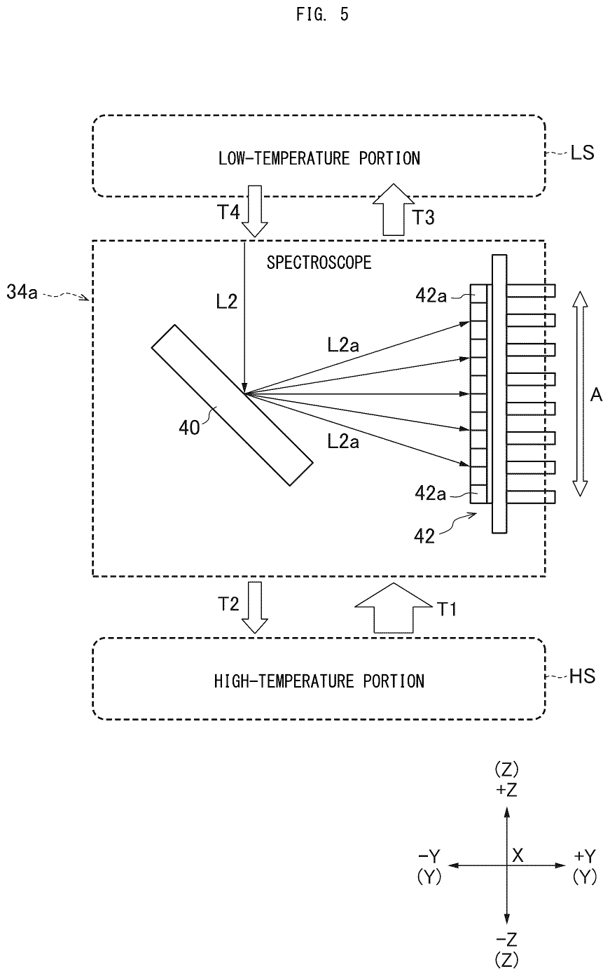

The low-emissivity members 44 and 46 will be described. The light source unit 32 is arranged on the −Z-direction side (corresponding to a first-direction side or a second-direction side according to the present invention) of the spectroscope 34. For this reason, the −Z-direction side of the spectroscope 34 may be warmed by light leaking out from the light source unit 32, radiant light from a region heated by the light source unit 32, and the like. It can be assumed that a high-temperature portion HS (see FIG. 5) at a higher temperature than the spectroscope 34 is arranged on the −Z-direction side of the spectroscope 34. Note that the power source 30 may be included in the high-temperature portion HS in addition to the light source unit 32. Since no unit is arranged on the +Z-direction side (corresponding to the second-direction side or the first-direction side according to the present invention) of the spectroscope 34, it can be assumed that a low-temperature portion LS (see FIG. 5) at a lower temperature than the spectroscope 34 is arranged on the +Z-direction side of the spectroscope 34.

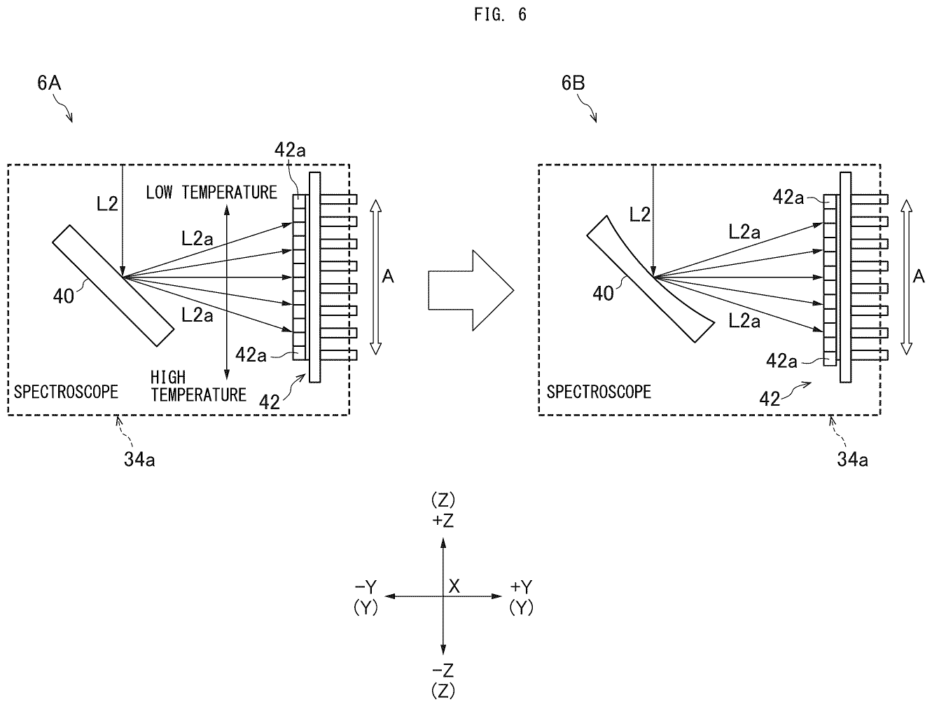

FIG. 5 is a diagram showing an example of a spectroscope 34a according to a comparative example without the low-emissivity members 44 and 46. FIG. 6 is an explanatory diagram for explaining a problem with the spectroscope 34a according to the comparative example. Note that the spectroscope 34a according to the comparative example has basically the same configuration as the spectroscope 34 except that the spectroscope 34a does not include the low-emissivity members 44 and 46.

As shown in FIG. 5, in the spectroscope 34a according to the comparative example without the low-emissivity members 44 and 46, emissivities at an end portion on the −Z-direction side and an end portion on the +Z-direction side are higher (reflectivities are lower) than in the spectroscope 34 with the low-emissivity members 44 and 46 (to be described later). For this reason, radiant heat T2 which is reflected from the end portion on the −Z-direction side of the spectroscope 34a is lower than radiant heat T1 which is transferred from the high-temperature portion HS to the end portion on the −Z-direction side of the spectroscope 34a to cause a larger rise in temperature of the end portion on the −Z-direction side of the spectroscope 34a.

Additionally, radiant heat T3 which is transferred from the end portion on the +Z-direction side of the spectroscope 34a to the low-temperature portion LS is higher than radiant heat T4 which is transferred from the low-temperature portion LS to the end portion on the +Z-direction side of the spectroscope 34a to cause a greater drop in temperature of the end portion on the +Z-direction side of the spectroscope 34a. This results in increase of a temperature gradient in the Z direction (a light dispersion direction A, or a long axis direction of a line sensor 42) of the spectroscope 34a.

When the temperature gradient in a Z direction of the spectroscope 34a increases as indicated by reference character 6A of FIG. 6, displacement or deformation of a grating surface of a spectroscopic element 40 (diffraction grating) may occur as indicated by reference character 6B of FIG. 6 to further cause non-uniform deformation of the line sensor 42 (not shown). In this case, wavelength calibration in the spectroscope 34a is disordered to degrade precision of the spectroscope 34a. For this reason, the spectroscope 34 according to the present embodiment is provided with the low-emissivity members 44 and 46, thereby reducing a temperature gradient in the Z direction of the spectroscope 34.

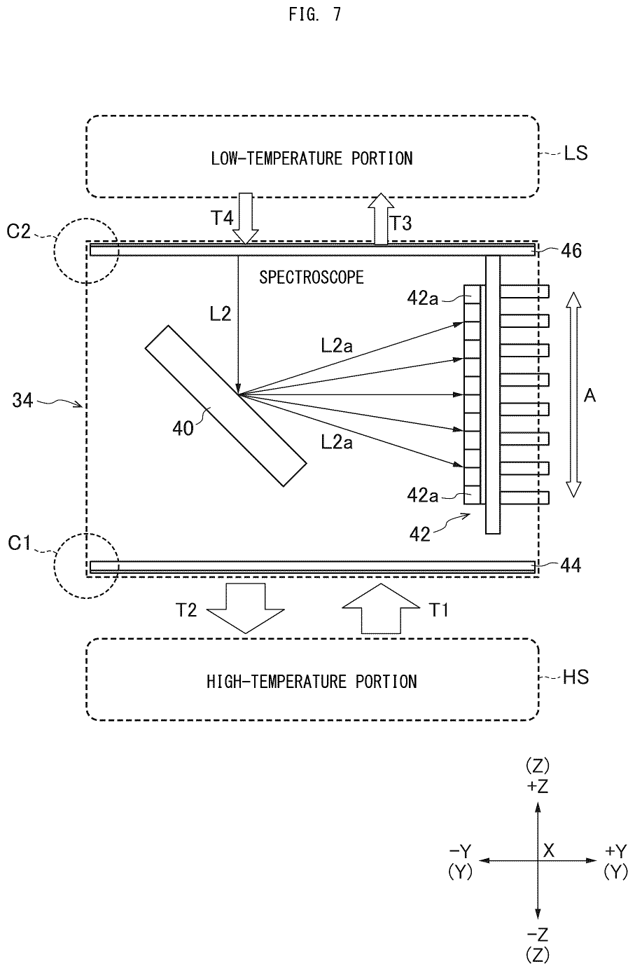

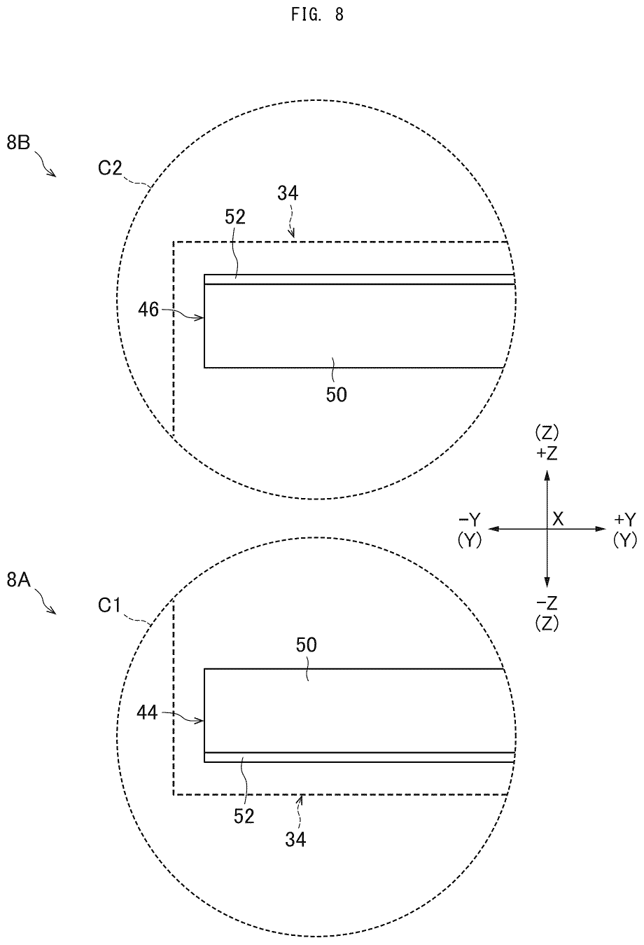

FIG. 7 is an explanatory diagram for explaining the low-emissivity members 44 and 46 of the spectroscope 34. FIG. 8 shows an enlarged view (see reference character 8A) of the low-emissivity member 44 in a dotted circle C1 in FIG. 7 and an enlarged view (see reference character 8B) of the low-emissivity member 46 in a dotted circle C2 in FIG. 7.

As shown in FIGS. 7 and 8, the low-emissivity members 44 and 46 are each formed in the shape of, for example, a flat plate parallel to an XY plane and have low emissivities (high reflectivities and low absorptivities). The emissivities of the low-emissivity members 44 and 46 are equal to or less than 0.15, more preferably equal to or less than 0.05. The low-emissivity member 44 is provided on the −Z-direction side (one-direction side in the light dispersion direction A) of the spectroscopic element 40 and the line sensor 42 and functions as a side wall portion on the −Z-direction side of the spectroscope 34. The low-emissivity member 46 is provided on the +Z-direction side (the other-direction side of the light dispersion direction A) of the spectroscopic element 40 and the line sensor 42 and functions as a side wall portion on the +Z-direction side of the spectroscope 34.

The low-emissivity member 44 includes, for example, a body portion 50 in the shape of a flat plate parallel to the XY plane and a low-emissivity layer 52 which is provided on a surface on the −Z-direction side of the body portion 50 (see reference character 8A in FIG. 8). Specifically, the body portion 50 (the low-emissivity member 44) is formed of aluminum, and an aluminum polished surface formed by polishing a surface on the −Z-direction side is used as the low-emissivity layer 52. The emissivity of the low-emissivity member 44 in this case is about 0.05.

A low-emissivity sheet (e.g., a metal foil sheet or an aluminum vapor-deposited sheet) may be attached as the low-emissivity layer 52 to the surface on the −Z-direction side of the body portion 50. The emissivity of the low-emissivity member 44 in a case where an aluminum vapor-deposited sheet is used as the low-emissivity layer 52 is, for example, about 0.04. In this case, a multilayer film of a metal layer with low emissivity and an insulator may be attached to the surface on the −Z-direction side of the body portion 50 instead of a low-emissivity sheet.

The low-emissivity member 46 has basically the same configuration as the low-emissivity member 44 except that the low-emissivity layer 52 is provided on a surface on the +Z-direction side of the body portion 50 (see reference character 8B in FIG. 8).

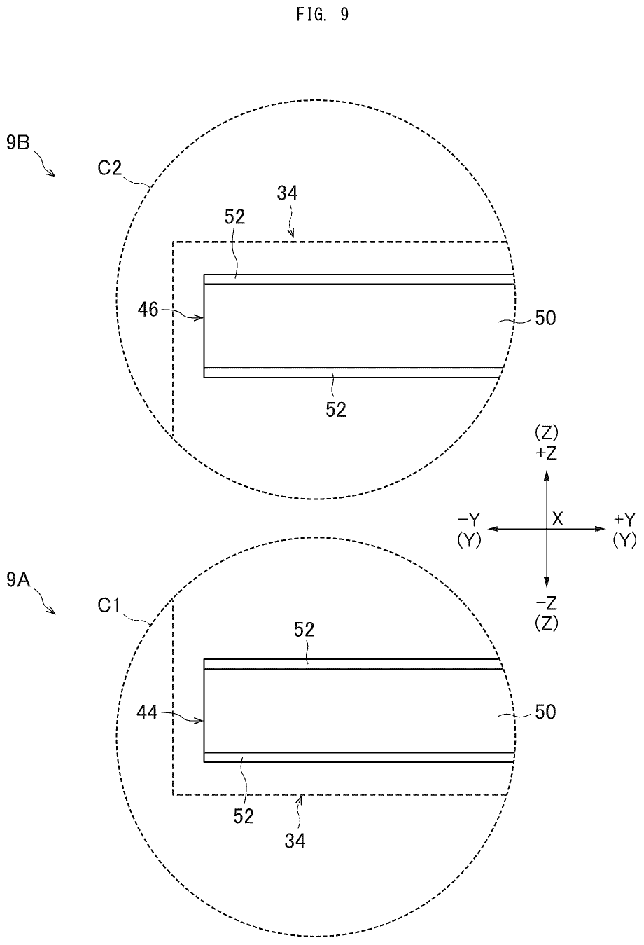

FIG. 9 is views of a modification (see reference character 9A) of the low-emissivity member 44 in the dotted circle C1 in FIG. 7 and a modification (see reference character 9B) of the low-emissivity member 46 in the dotted circle C2 in FIG. 7. As indicated by reference character 9A in FIG. 9, the low-emissivity layer 52 may be provided on each surface in the Z direction of the body portion 50 instead of providing the low-emissivity layer 52 only on the surface on the −Z-direction side of the body portion 50 of the low-emissivity member 44. As indicated by reference character 9B in FIG. 9, the low-emissivity layer 52 may be provided on each surface in the Z direction of the body portion 50 instead of providing the low-emissivity layer 52 only on the surface on the +Z-direction side of the body portion 50 of the low-emissivity member 46.

Refer back to FIG. 7, with provision of the low-emissivity member 44 on the −Z-direction side of the spectroscopic element 40 and the line sensor 42, radiant heat T1 transferred from a high-temperature portion HS to an end portion on the −Z-direction side of the spectroscope 34 is reflected by the low-emissivity member 44. For this reason, radiant heat T2 to be reflected by the end portion on the −Z-direction side of the spectroscope 34 is higher than in the comparative example shown in FIG. 5 (hereinafter simply referred to as the comparative example). As a result, a rise in temperature of the end portion on the −Z-direction side of the spectroscope 34 can be made smaller than in the comparative example.

Additionally, with provision of the low-emissivity member 46 on the +Z-direction side of the spectroscopic element 40 and the line sensor 42, radiant heat T3 transferred from an end portion on the +Z-direction side of the spectroscope 34 to a low-temperature portion LS is reduced by the low-emissivity member 46. As a result, a drop in temperature of the end portion on the +Z-direction side of the spectroscope 34 can be made smaller than in the comparative example.

With the above-described provision of the low-emissivity member 44 on the −Z-direction side of the spectroscopic element 40 and the line sensor 42 and the low-emissivity member 46 on the +Z-direction side, a temperature gradient in the Z direction (the light dispersion direction A, or a long axis direction of the line sensor 42) of the spectroscope 34 can be made lower than in the comparative example. This results in inhibition of displacement or deformation of a grating surface of the spectroscopic element 40 (diffraction grating) and non-uniform deformation of the line sensor 42. Since this inhibits disorder of wavelength calibration in the spectroscope 34, precision of the spectroscope 34 can be made higher than ever before.

The reason to inhibit only occurrence of a temperature gradient in the Z direction (the light dispersion direction A, or the long axis direction of the line sensor 42) in the spectroscope 34 according to the first embodiment will be described.

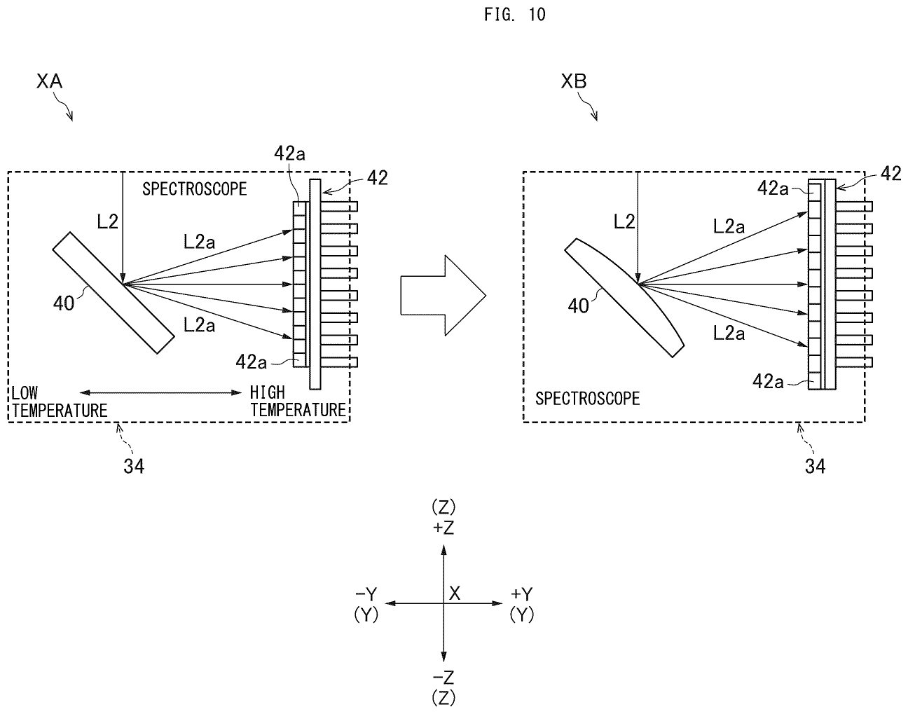

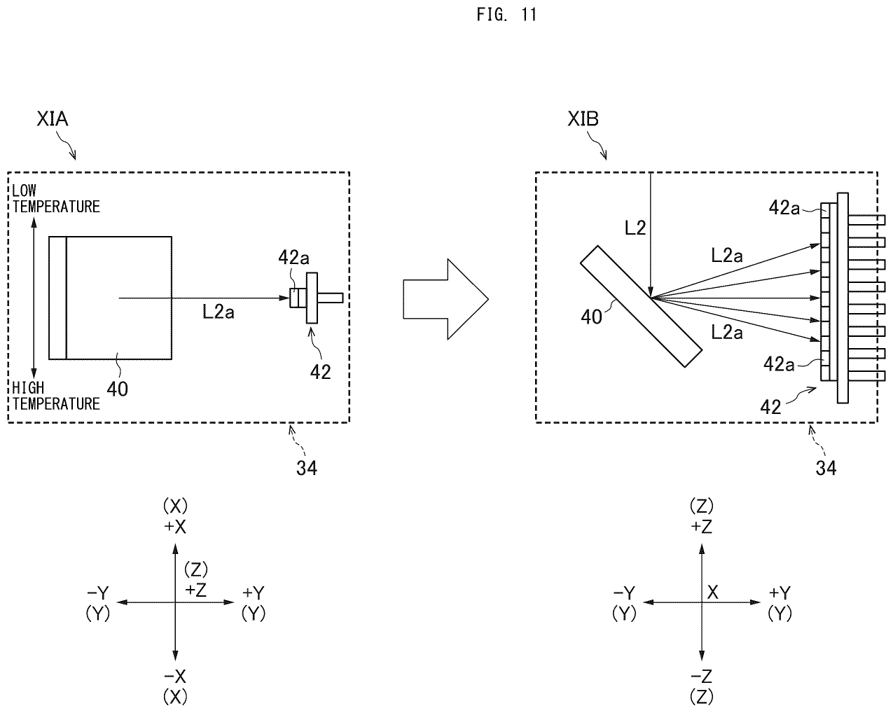

Reference characters XA and XB in FIG. 10 denote diagrams showing a case where there is a temperature gradient in the Y direction of the spectroscope 34. Reference characters XIA and XIB in FIG. 11 denote diagrams showing a case where there is a temperature gradient in the X direction of the spectroscope 34. Note that reference character XIA in FIG. 11 denotes a diagram of the spectroscope 34 as viewed from the +Z-direction side. The low-emissivity members 44 and 46 are not shown in FIGS. 10 and 11 for illustrative brevity.

Even in a case where there is a temperature gradient in the Y direction of the spectroscope 34 as indicated by reference characters XA and XB in FIG. 10, the line sensor 42 is uniformly deformed (not shown). For this reason, an error in wavelength calibration in the spectroscope 34 is smaller than in a case where there is a temperature gradient in the Z direction as in the above-described comparative example.

Even in a case where there is a temperature gradient in the X direction of the spectroscope 34 as indicated by reference characters XIA and XIB in FIG. 11, the spectroscopic element 40 and the line sensor 42 are just deformed in the X direction. For this reason, an error in wavelength calibration in the spectroscope 34 is smaller than in a case where there is a temperature gradient in the Z direction as in the above-described comparative example.

Thus, just reducing a temperature gradient in the Z direction by the low-emissivity members 44 and 46 as in the spectroscope 34 according to the first embodiment allows improvement of the precision of the spectroscope 34.

### Second Embodiment

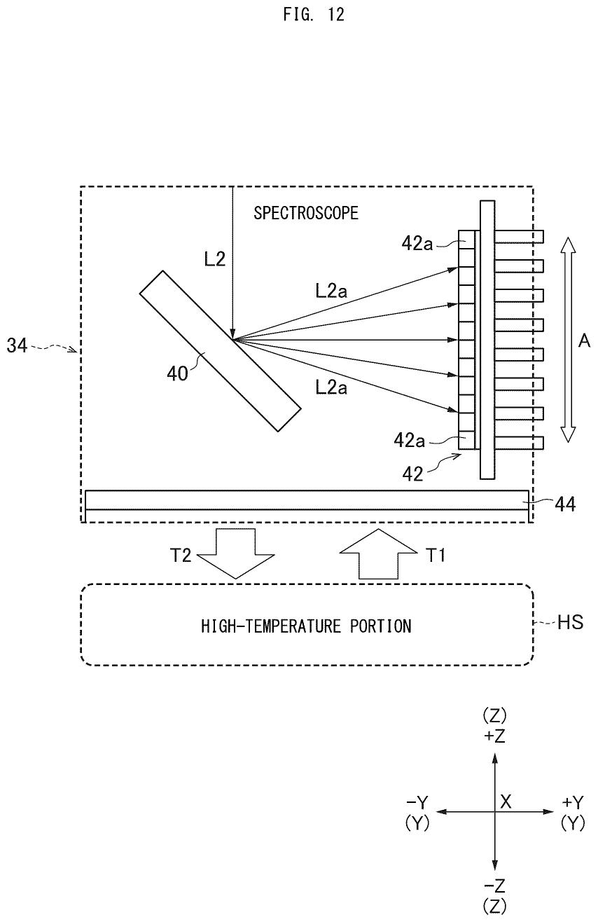

FIG. 12 is a schematic diagram of a spectroscope 34 of a displacement gage 10 according to a second embodiment. Although, in the spectroscope 34 according to the above-described first embodiment, the low-emissivity member 44 is provided on the −Z-direction side of the spectroscopic element 40 and the line sensor 42, and the low-emissivity member 46 is provided on the +Z-direction side, a low-emissivity member 44 may be provided only on a −Z-direction side of a spectroscopic element 40 and a line sensor 42, as shown in FIG. 12.

Note that the displacement gage 10 according to the second embodiment has basically the same configuration as in the first embodiment except that a low-emissivity member 46 of the spectroscope 34 is omitted. Elements functionally or constitutionally the same as in the first embodiments are denoted by the same reference numerals, and a description thereof will be omitted.

Just providing the low-emissivity member 44 only between the spectroscope 34 (the spectroscopic element 40 and the line sensor 42) and a high-temperature portion HS as in the second embodiment makes a rise in temperature of an end portion on the −Z-direction side of the spectroscope 34 due to influence of the high-temperature portion HS smaller than in the comparative example. This makes a temperature gradient in a Z direction of the spectroscope 34 lower than in the comparative example. As a result, precision of the spectroscope 34 can be improved.

### Third Embodiment

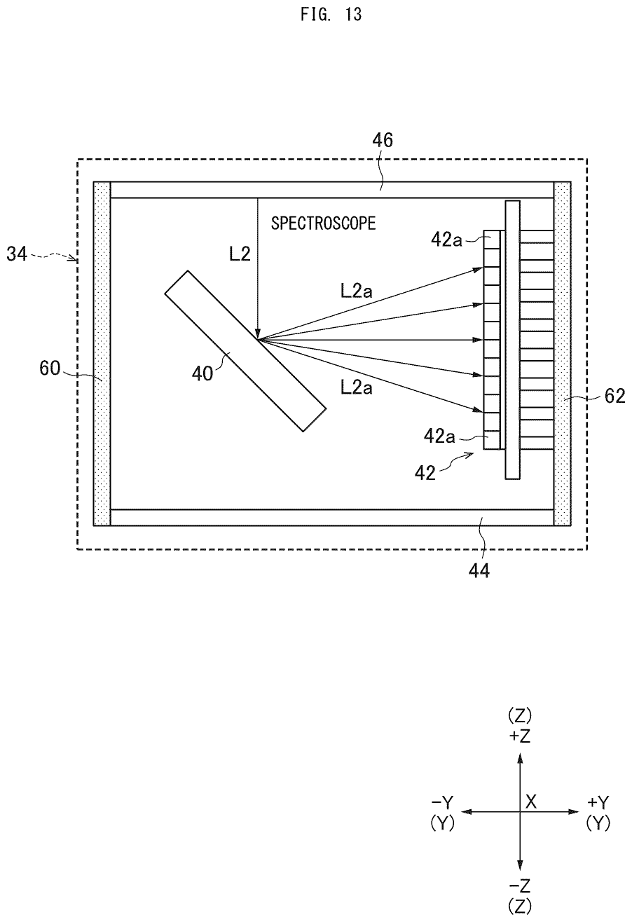

FIG. 13 is a schematic diagram of a spectroscope 34 of a displacement gage 10 according to a third embodiment. As shown in FIG. 13, the displacement gage 10 according to the third embodiment has basically the same configuration as the displacement gages 10 according to the above-described embodiments except that the spectroscope 34 is provided with high-emissivity members 60 and 62. Elements functionally or constitutionally the same as in the embodiments are denoted by the same reference numerals, and a description thereof will be omitted.

The high-emissivity members 60 and 62 are each formed in the shape of, for example, a flat plate parallel to a ZX plane and have high emissivities (low reflectivities and high absorptivities). The emissivities of the high-emissivity members 60 and 62 are equal to or more than 0.4, more preferably equal to or more than 0.5. The high-emissivity member 60 is provided on a −Y-direction side (corresponding to a fourth-direction side according to the present invention) of a spectroscopic element 40 and functions as a side wall portion on the −Y-direction side of the spectroscope 34. The high-emissivity member 62 is provided on a +Y-direction side of the line sensor 42 and functions as a side wall portion on the +Y-direction side of the spectroscope 34.

The high-emissivity members 60 and 62 are obtained by, for example, subjecting two surfaces (one surface is acceptable) of an aluminum plate parallel to the ZX plane to alumite treatment, more preferably matte-black alumite treatment. The emissivities are about 0.5 in a case where the high-emissivity members 60 and 62 are subjected to alumite treatment (alumite surfaces are formed) and are about 0.95 in a case where the high-emissivity members 60 and 62 are subjected to matte-black alumite treatment (matte-black alumite surfaces are formed).

As the high-emissivity members 60 and 62, aluminum plates parallel to the ZX plane whose two surfaces (one surface is acceptable) are increased in the degree of surface roughness may be used. The emissivities are about 0.4 in a case where the high-emissivity members 60 and 62 are subjected to blasting to increase the degree of surface roughness.

The above-described provision of the high-emissivity members 60 and 62 on the −Y-direction side and the +Y-direction side of the spectroscope 34 facilitates a quick heat exchange between a surrounding environment (e.g., a high-temperature portion HS and a low-temperature portion LS) and a housing of the spectroscope 34. For this reason, the spectroscope 34 reaches thermal equilibrium with the surrounding environment in a shorter time. As a result, a time from when the displacement gage 10 is activated to when the spectroscope 34 is stabilized (reaches thermal equilibrium) can be shortened, which further improves economy.

Although provision of the high-emissivity members 60 and 62 in the spectroscope 34 may cause a temperature gradient in a Y direction of the spectroscope 34 as shown in FIG. 10 described earlier, a temperature gradient in the Y direction does not largely affect precision of the spectroscope 34 as described above. Thus, the spectroscope 34 according to the third embodiment can achieve both improvement of the precision and improvement of economy.

### Fourth Embodiment

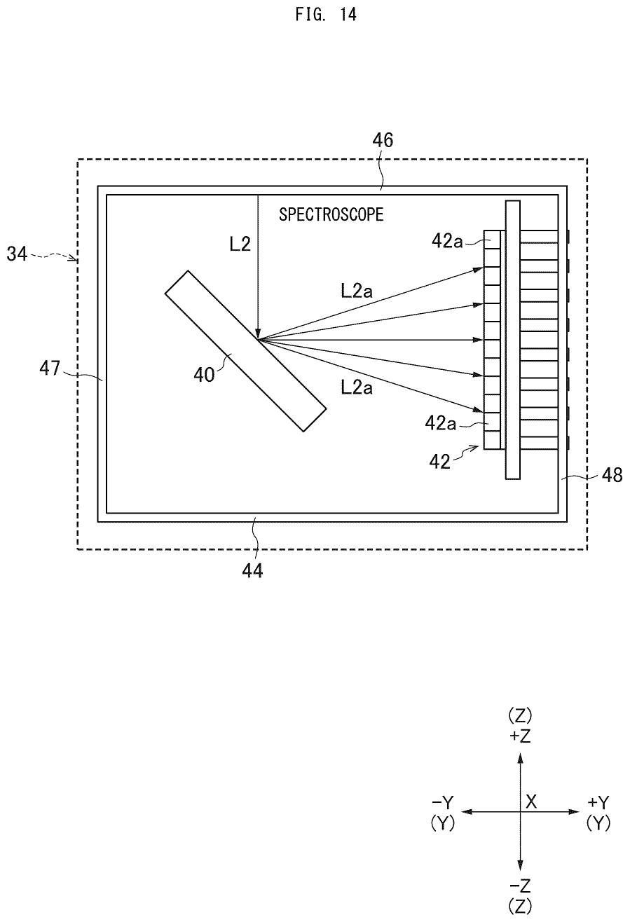

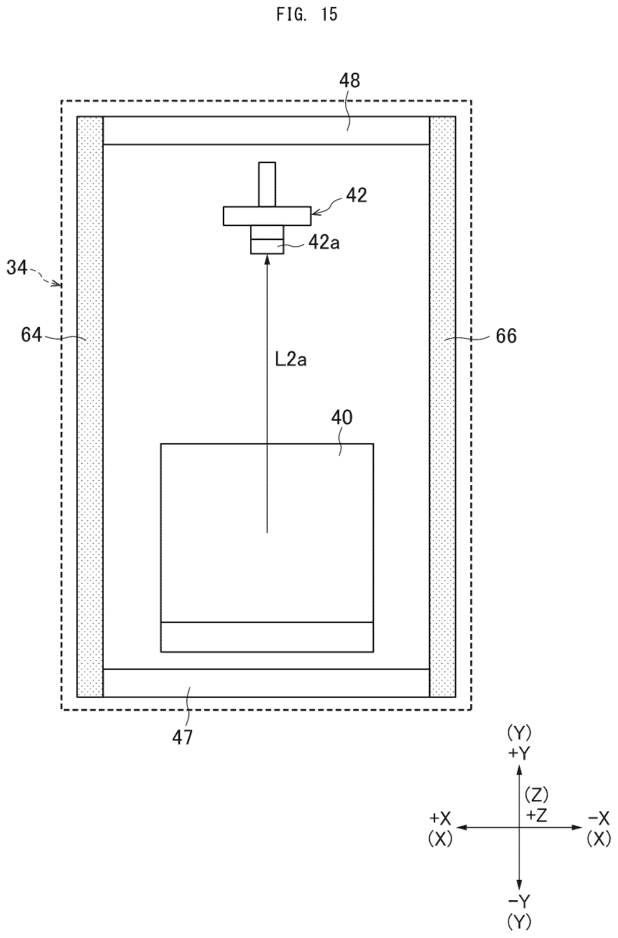

FIG. 14 is a view of a spectroscope 34 of a displacement gage 10 according to a fourth embodiment as viewed from an X-direction side. FIG. 15 is a view of the spectroscope 34 of the displacement gage 10 according to the fourth embodiment as viewed from a +Z-direction side. As shown in FIGS. 14 and 15, the displacement gage 10 according to the fourth embodiment has basically the same configuration as the displacement gage 10 according to the above-described first embodiment except that the displacement gage 10 includes low-emissivity members 47 and 48 and high-emissivity members 64 and 66. Elements functionally or constitutionally the same as in the first embodiments are denoted by the same reference numerals, and a description thereof will be omitted.

The low-emissivity members 47 and 48 are each formed in the shape of, for example, a flat plate parallel to an XZ plane and are basically the same as the low-emissivity members 44 and 46 described earlier. Note that emissivities of the low-emissivity members 47 and 48 may be the same as or different from the emissivities of the low-emissivity members 44 and 46.

The low-emissivity member 47 is provided on a −Y-direction side of a spectroscopic element 40 and functions as a side wall portion on the −Y-direction side of the spectroscope 34. Note that a low-emissivity layer 52 (see FIGS. 8 and 9) is preferably formed on a surface on the −Y-direction side of the low-emissivity member 47 or on each surface in a Y direction.

The low-emissivity member 48 is provided on a +Y-direction side of a line sensor 42 and functions as a side wall portion on the +Y-direction side of the spectroscope 34. Note that the low-emissivity layer 52 (see FIGS. 8 and 9) is preferably formed on a surface on the +Y-direction side of the low-emissivity member 48 or on each surface in the Y direction.

The high-emissivity members 64 and 66 are each formed in the shape of, for example, a flat plate parallel to a YZ plane and are basically the same as the high-emissivity members 60 and 62 described earlier. Note that emissivities of the high-emissivity members 64 and 66 may be the same as or different from the emissivities of the high-emissivity members 60 and 62.

The high-emissivity member 64 is provided on a +X-direction side (corresponding to a fifth-direction side according to the present invention) of the spectroscopic element 40 and the line sensor 42 and functions as a side wall portion on the +X-direction side of the spectroscope 34. The high-emissivity member 66 is provided on a −X-direction side (corresponding to a sixth-direction side of the present invention) of the spectroscopic element 40 and the line sensor 42 and functions as a side wall portion on the −X-direction side of the spectroscope 34.

As described above, in the spectroscope 34 according to the fourth embodiment, emissivities in a Z direction and the Y direction are reduced, and an emissivity in an X direction is increased. Since the spectroscope 34 according to the fourth embodiment is increased in the emissivity in the X direction that does not largely affect precision of the spectroscope 34, the spectroscope 34 reaches thermal equilibrium with a surrounding environment in a shorter time after the displacement gage 10 is activated, as in the above-described third embodiment. In the spectroscope 34 according to the fourth embodiment, temperature gradients in the Y direction and the Z direction (particularly the Z direction) are reduced, and the precision of the spectroscope 34 can be improved, as in the above- described embodiments. As a result, the spectroscope 34 according to the fourth embodiment can achieve both improvement of the precision and improvement of economy.

Note that it is acceptable to reduce the emissivities in the Z direction and the X direction and increase the emissivity in the Y direction, instead of reducing the emissivities in the Z direction and the Y direction and increasing the emissivity in the X direction as in the spectroscope 34 according to the fourth embodiment.

### Fifth Embodiment

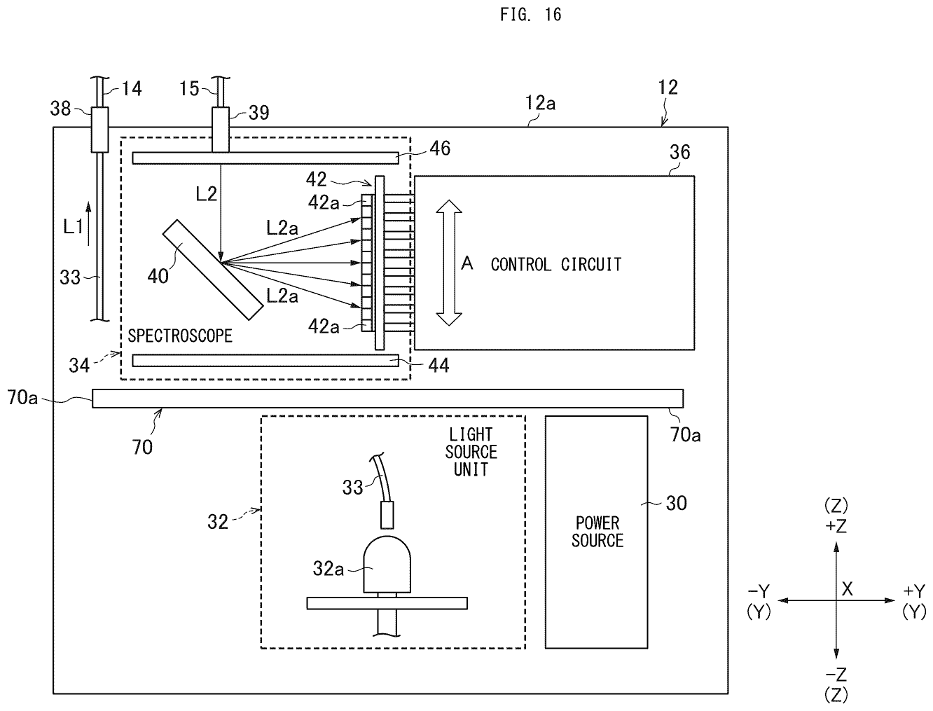

FIG. 16 is a schematic diagram of a controller 12 of a displacement gage 10 according to a fifth embodiment. As shown in FIG. 16, the displacement gage 10 according to the fifth embodiment has basically the same configuration as the displacement gages 10 according to the above-described embodiments except that a partition wall 70 (also referred to as a screen or a wall portion) is provided in the controller 12.

The partition wall 70 is provided between a spectroscope 34, and a power source 30 and a light source unit 32 (a high-temperature portion HS) and is formed in the shape of a screen which serves as a divider therebetween (the shape of a flat plate parallel to an XY plane). This prevents radiant heat T1 from the high-temperature portion HS, such as the light source unit 32, from being directly transferred to an end portion on a −Z-direction side of the spectroscope 34. That is, since the radiant heat T1 from the high-temperature portion HS is transferred to the spectroscope 34 while coming around the partition wall 70, a heat flow only to a particular surface (a surface on the −Z-direction side here) of the spectroscope 34 can be inhibited from increasing. As a result, temperature uniformity of the spectroscope 34 is enhanced, which allows further improvement of precision of the spectroscope 34.

In this case, it is preferable that the partition wall 70 not completely partition a space between the spectroscope 34, and the power source 30 and the light source unit 32 but have one or a plurality of opening portions 70a. Passage of air through the opening portion(s) 70a brings the spectroscope 34 and the high-temperature portion HS, such as the light source unit 32, into thermal equilibrium in a short time. As a result, a temperature distribution of the spectroscope 34 can be made uniform in a shorter time.

### Others

The light source unit 32 and the power source 30 (only either one is acceptable) have been described as examples of the high-temperature portion HS in the above-described embodiments. For example, various devices, members, and mechanisms, such as the control circuit 36 (e.g., a CPU), which become hotter than the spectroscope 34 may be included in the high-temperature portion HS.

Although the line sensor 42 has been described as an example of the detector according to the present invention in each of the embodiments, an area sensor in which the pixels 42a are arranged in a two-dimensional array may be used as the detector according to the present invention.

Although the low-emissivity member 44 is provided on the −Z-direction side of the spectroscope 34 and the line sensor 42 in each of the embodiments, the low-emissivity member 44 may be provided only on the −Z-direction side of either one of the spectroscope 34 and the line sensor 42. The low-emissivity member 46 may be provided only on the +Z-direction side of either one of the spectroscope 34 and the line sensor 42.

Although the configuration shown in FIG. 8 or 9 has been described as an example for each of the low-emissivity members 44 and 46 to 48 in each of the embodiments, the type of each of the low-emissivity members 44 and 46 to 48 is not particularly limited as long as the low-emissivity member is an inhibiting member (including heat insulating materials and heat reflectors [a heat reflecting plate and heat reflecting glass]) capable of inhibiting (reducing) a change in temperature of the spectroscope 34 due to influence of a surrounding environment (e.g., the high-temperature portion HS and the low-temperature portion LS).

Although the displacement gage 10 has been described as an example of an optical device including the spectroscope 34 according to the present invention in each of the embodiments, the present invention can also be applied to various optical devices including the spectroscope 34, such as a thickness measurement device including the spectroscope 34.

### REFERENCE SIGNS LIST

10 displacement gage
11 color confocal optical system
12 controller
12a case
13 optical fiber cable
13a fiber end face
14, 15 optical fiber cable
16 optical fiber coupler
20 lens-barrel
21 objective lens
22 ocular
30 power source
32 light source unit
32a LED light source
33 optical fiber cable
34 spectroscope
34a spectroscope
36 control circuit
38 exit connector
39 entrance connector
40 spectroscopic element
42 line sensor
42a pixel
44, 46 to 48 low-emissivity member
50 body portion
52 low-emissivity layer
60, 62, 64, 66 high-emissivity member
70 partition wall
70a opening portion
A light dispersion direction
HS high-temperature portion
L1 measurement light
L2 reflected light
L2a light component
LS low-temperature portion
T1 to T4 radiant heat
W workpiece

What is claimed is:

1. A spectroscope comprising:
a spectroscopic element configured to disperse incident light in accordance with wavelengths;
a detector having a plurality of pixels and configured to receive wavelength-specific light components obtained through light dispersion by the spectroscopic element at ones different from each other of the pixels; and
a low-emissivity member provided on at least one of a first-direction side and a second-direction side of the spectroscopic element and the detector in a case where a one-direction side of a light dispersion direction of the spectroscopic element is the first-direction side, and an other-direction side of the light dispersion direction is the second-direction side.

2. The spectroscope according to claim 1, wherein, in a case where a direction parallel to a plane including the wavelength-specific light components obtained through light dispersion by the spectroscopic element and perpendicular to the light dispersion direction is a first perpendicular direction, and a one-direction side of the first perpendicular direction is a third-direction side, the detector is provided on the third-direction side of the spectroscopic element.

3. The spectroscope according to claim 2, wherein the low-emissivity member comprises low-emissivity members provided on the first-direction side and the second-direction side of the spectroscopic element and the detector.

4. The spectroscope according to claim 2, wherein, in a case where a high-temperature portion at a higher temperature than the spectroscope is provided on the first-direction side or the second-direction side of the spectroscopic element and the detector, the low-emissivity member is provided between the spectroscopic element and the detector, and the high-temperature portion.

5. The spectroscope according to claim 3, comprising high-emissivity members provided on a fourth-direction side of the spectroscopic element and the third-direction side of the detector in a case where an other-direction side of the first perpendicular direction is the fourth-direction side.

6. The spectroscope according to claim 3, wherein
in a case where an other-direction side of the first perpendicular direction is a fourth-direction side, a direction perpendicular to the light dispersion direction and the first perpendicular direction is a second perpendicular direction, a one-direction side of the second perpendicular direction is a fifth-direction side, and an other-direction side of the first perpendicular direction is a sixth-direction side, the low-emissivity member further comprises low-emissivity members provided on the fourth-direction side of the spectroscopic element and the third-direction side of the detector, and
the spectroscope comprises high-emissivity members provided on the fifth-direction side and the sixth-direction side of the spectroscopic element and the detector.

7. The spectroscope according to claim 1, wherein the detector is a line sensor having the plurality of pixels arrayed in the light dispersion direction.

8. An optical device comprising:
a spectroscope according to claim 1;
a high-temperature portion provided on the first-direction side or the second- direction side of the spectroscope and at a higher temperature than the spectroscope; and
a partition wall provided between the spectroscope and the high-temperature portion.

9. The optical device according to claim 8, wherein an opening portion is formed in the partition wall.

10. The optical device according to claim 8, wherein the high-temperature portion is a light source unit.
